(19) United States
(12) Patent Application Publication
(10) Pub. No.: US 2003/0027460 A1
(43) Pub. Date: Feb. 6, 2003

(54) Device and method for connecting an electric device to a power source

(76) Inventor: Lilian (Leah) Atad, Qazrin (IL)

Correspondence Address: DR. MARK FRIEDMAN LTD., c/o BILL POLKINGHORN-DISCOVERY DISPATCH, 9003 FLORIN WAY, UPPER MARLBORO, MD, 20772, US

(21) Appl. No.: 09/918,452

(22) Filed: Aug. 1, 2001

(51) Int. Cl. H01R 13/04

(52) U.S. Cl. 439/694

(57) ABSTRACT

A method and system for reducing the space required for an electric connection. A plug and socket are described that are shaped in a banana type fashion. Banana type plugs and sockets according to the present invention conduct an electric current with an upper limit of between 0.15 and 16 amperes. This invention addresses the need for a universal plug and socket by describing a banana type plug and socket which could be adopted by many countries which today are plagued by different plugs and sockets in different areas, necessitating all kinds of intricate adapters.

### FIELD AND BACKGROUND OF THE INVENTION

The present invention relates to devices and a method for connecting electric appliances to a power source and, more particularly, to an improved configuration for plugs and sockets suited for use with household current (i.e. 110 volt or 220 volt). Sockets according to the present invention may be grouped more closely than conventional sockets, thereby saving space and allowing installation of a larger number of sockets.

Although banana jack type plugs, which rely on concentric insertion prongs, are known, their use has typically been restricted to low voltage applications such DC current, typically in the range of 1.5 volts to 12 volts. Typical applications involve a connection between a stepdown transformer and an appliance operating on low voltage DC current.

U.S. Pat. No. 4,787,862 to Lee teaches an apparatus for electrically connecting two audio components utilizing different sized conductors in which first and second connector blocks have first terminals for respectively connecting the conventional terminals of the audio components. Each connector block has a plurality of additional terminals electrically connected to the first terminal. A plurality-of electrical conductors, having different electrical current transfer characteristics, are connected between two corresponding additional terminals of the connector blocks to complete the connection. Teachings of this patent do not include connectors suited for use with household AC current, but are limited to the low DC currents typically required to transfer an audio signal from one component to another.

U.S. Pat. No. 4,585,286 to Par teaches a plug adapter which converts a three prong male household plug to a three-prong male OSHA twistlock connector, and vise versa. The adapter has a cylindrical body with a block having a set of prongs adapted to fit a twist lock receptacle, and a set of prongs adapted to fit a standard three socket receptacle. The block is adapted to reciprocate between two end plates, each having a plurality of apertures to permit passage of the respective set of prongs. When one set of prongs is extended, the opposite plate serves as a receptacle to receive a mating male connector. Teachings of this patent do not include connectors relying on matched pairs of concentric contact surfaces.

Various connectors have been disclosed which have interchangeable socket and pin arrangements. For example, U.S. Pat. No. 3,885,849 to Bailey et el. teaches an electrical connector with interchangeable components. The connector consists of a housing and different types of molded male and female inserts which can be readily assembled with the housing and removed therefrom so that different configurations may be obtained. Another modular connector is disclosed in U.S. Pat. No. 4,158,473 to Shearer. This connector consists of a plastic cylindrical plug and receptacle, each having a plurality of cavities extending longitudinally therethrough. The cavities are adapted to receive a corresponding plurality of plastic modules. Each module has a plurality of holes for receiving electrical contact pins or sockets. The modules have locking tabs which lock the modules in place. Teachings of this patent do not include connectors relying on matched pairs of concentric contact surfaces.

U.S. Pat. No. 4,900,270 to Edwards et al. teaches a cable adapter assembly that allows a plurality of plugs to be used with a plurality of sockets. The arrangement consists of at least two cable members, each having a plug and socket separated by an electric cord wherein the plug and socket on any given cable member are of distinctly distinct configurations. This assembly is designed to permit an operator to quickly adapt a given electric plug from an appliance to a particular wall outlet. Teachings of this patent do not include anything concerning having connections saving space.

None of the prior art cited herein specifically address the problem of having a universal plug and socket. Others prior art have various adaptive features between one electric type plug and socket and another and none of them address the clutter created by the space occupied by a multiple gang outlet

There is thus a widely recognized need for, and it would be highly advantageous to have, devices and methods for connecting electric appliances to a power source devoid of the above limitation.

### SUMMARY OF THE INVENTION

According to one aspect of the present invention there is provided a method of reducing the space required for an AC electric connection. The method comprises the steps of arranging at least two nested insulated electric contact surfaces, the arranging arranged such that the at least two nested insulated electric contact surfaces are longer in the axial direction than in the transverse direction, and providing an AC current suitable for powering an electric device wherein the contact surfaces are constructed to safely conduct an electric current supplied by a power grid.

According to another aspect of the present invention there is provided an electrical connection for AC current supplied by a power grid. The connection includes a socket, the socket including at least two recessed nested contact surfaces, each of the recessed nested contact surfaces constructed of a conductive material; and insulating material, the insulating material effectively preventing a flow of electric current between the recessed nested contact surfaces; a socket housing; the socket housing containing the at least two recessed nested contact surfaces and the insulating material. The connection further includes a plug, the plug comprising at least two protruding nested contact surfaces, each of the protruding nested contact surfaces constructed of a conductive material; and insulating material, the insulating material effectively preventing a flow of electric current between the protruding nested contact surfaces a plug housing; the plug housing containing the at least two protruding nested contact surfaces and the insulating material; and wherein the plug is insertable in the socket such that the electrical connection is formed; and wherein the connection is capable of safely conducting an electric current supplied by a power grid.

According to further features in preferred embodiments of the invention described below, the at least two recessed and protruding nested insulated electric contact surfaces fulfill functions selected from the group consisting of plus lead; a minus lead; and a ground lead.

According to still further features in the described preferred embodiments, the power grid supplies a potential difference range of 100 volts to 250 volts AC.

According to still further features in the described preferred embodiments, the potential difference is approximately 110 volts AC.

According to still further features in the described preferred embodiments, the potential difference is approximately 220 volts AC.

According to still further features in the described preferred embodiments, the electric current has an upper limit in the range of 0.15 amperes to 16 amperes.

According to still further features in the described preferred embodiments, the electric current has an upper limit in the range of 0.15 amperes to 5 amperes.

According to still further features in the described preferred embodiments, the electric current has an upper limit in the range of 2.5 amperes to 10 amperes.

According to still further features in the described preferred embodiments, the at least two recessed nested insulated electric contact surfaces are each independently characterized by a perpendicular cross section selected from the group consisting of a circle, a rectangle, a square, a triangle, an ellipse, and another polygon.

According to still further features in the described preferred embodiments, the at least two protruding nested insulated electric contact surfaces are each independently characterized by a perpendicular cross section selected from the group consisting of a circle, a rectangle, a square, a triangle, an ellipse, and another polygon.

According to still further features in the described preferred embodiments, the at least two nested insulated electric contact surfaces are concentrically arranged.

According to still further features in the described preferred embodiments, the at least two nested insulated electric contact surfaces are non-concentrically arranged.

According to still further features in the described preferred embodiments, the at least two nested insulated electric contact surfaces comprise three nested insulated electric contact surfaces: an innermost plus lead; an intermediate minus lead; and an outermost ground lead.

According to still further features in the described preferred embodiments, a perpendicular cross-sectional surface area of the socket housing and the plug housing are each less than approximately 3 square centimeters.

The present invention successfully addresses the shortcomings of the presently known configurations by providing a system and method for reducing the area required for an electric connection.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a view of a plug according to this invention, 1a is a side view, 1b is a cross-sectional view from the posterior and 1c is a posterior view;

FIG. 2 is a schematic representation of the outlet according to the teachings of this invention, 2a is a side view of the multiple gang outlet in the wall and 2b is a view of the outlet from the exterior; and 2c is a view of the outlet from the interior of the wall showing electrical connections.

### DESCRIPTION OF THE PREFERRED EMBODIMENTS

The present invention is of a system and method for safely conducting an electric current supplied by a power grid. Specifically, the present invention can be used to reduce the area required for an electric connection.

The principles and operation of an electrical connection according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase “standard plugs and outlets” includes but is not limited to plugs and outlets in common use with electrical devices prior to the plug and outlets disclosed in the present invention.

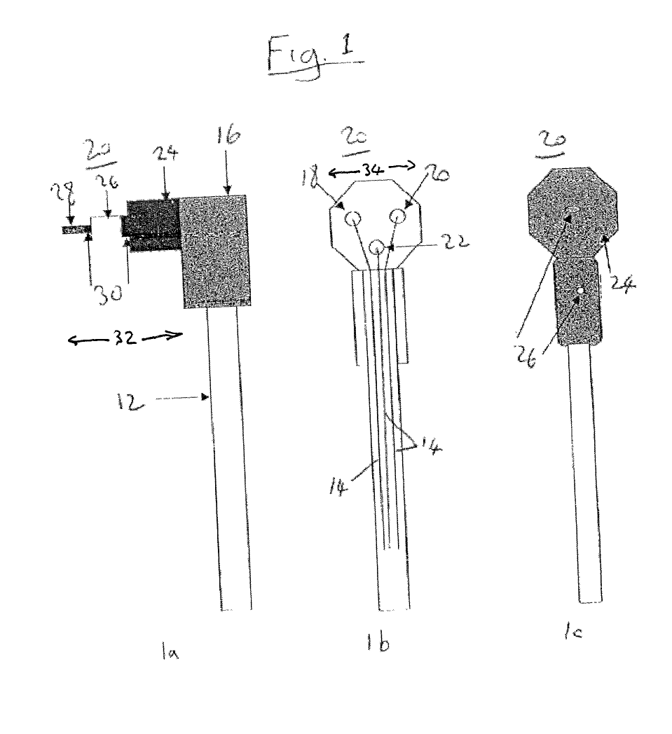

Referring now to the drawings, FIG. 1 illustrates the plug according to this invention. The figure illustrates a plug required for an electric connection. FIG. 1a is a side view of a “banana” like jack plug. From the side it is possible to see that the at least two nested insulated electric contact surfaces 24,26,28 are longer in the axial direction 32 than in the transverse direction 34 (FIG. 1b). The essence of this patent is that the connection is a deep one instead of a lateral one. Lateral electric connections which are in universal use today have two or three prongs arranged protruding perpendicularly from a plug surface which connect into two or three female receptors arranged transversely across an outlet or extension. This invention is a method of reducing the space required for an AC electric connection as the surface area required to establish the AC electric connection of an electric device according to this invention is not greater than approximately 3 square centimeters which is much smaller than an electric connection of an electric device with a standard electric connection used in most countries. An AC electric connection for high amperage devices such as air conditioners would have wider banana type plugs and outlets that would be supplied with higher amperage from the power grid. Wider plugs and outlets are visibly distinguished from lower amperage connections.

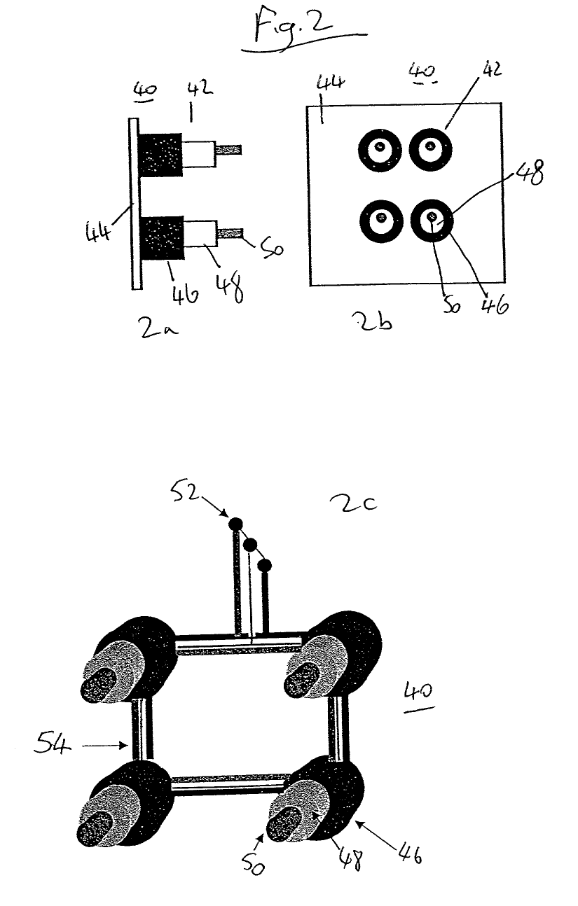

Two or three electricity conducting wires 14 (FIG. 2b) traverse a cord 12 from an AC electric device to the plug housing 16. Wires 14 traversing cord 12 run in parallel each individually insulated or alternately are arranged coaxially. Wires 14 in plug housing 16 are connected to a plus or otherwise known as a hot or a phase lead 18, a minus or otherwise known as a neutral lead 20 and a ground lead 22. A plus and a minus lead exist in all the plugs according to this invention. Most devices have a ground lead as well, which necessitate a three-pronged plug as illustrated in FIG. 1. A two-pronged plug and/or outlet can be used where the device does not have a grounding prong. FIG. 1c illustrates the posterior cover 24 of plug housing 16 showing the closing screws 26. Three distinct nested electrically conductive sleeve zones 24,26 and 28 protruding from plug housing 16 are axially spaced apart by insulating separators 30. In a preferred embodiment of the present invention the outermost or the visibly closest and widest zone to plug housing 16 is the ground zone 24, the intermediate sleeve zone is the neutral zone 26 and the innermost or farthest and narrowest sleeve zone from plug housing 16 is the plus or hot zone 28.

FIG. 2 illustrates a multiple gang outlet 40. FIG. 2a is a side view of a socket in a wall showing a side view of two sockets 42 sunken within a wall and a wall plate 44 into which sockets 42 are formed or attached. FIG. 2b illustrates a four-gang outlet. The multiple-gang outlet can have any amount of sockets. The individual sockets include corresponding female components to the male plug components described above. A socket includes at least two recessed nested contact surfaces. When the connection does require a ground connection as most connections do, there are three recessed nested contact surfaces a hot contact surface 50, a neutral contact surface 48 and a ground contact surface 46. Hot contact surface 50 is preferably place in the innermost position within the connection such that the current does not flow until the male plug is inserted all of the way into the female matching socket. In most cases when a ground contact is required then there will be three prongs with the ground surface being the widest and closest to the wall in case of a wall mounted multiple gang outlet or to the cover of a free-standing outlet. When grounded contacts are not required, two contact surfaces, a hot one and a neutral one are sufficient. In the case of multiple phase electric connections there can be more contact surfaces according to the number of phases. Each of the recessed nested contact surfaces is constructed of a conductive material; and insulating material, the insulating material effectively preventing a flow of electric current between the recessed nested contact surfaces and a socket housing; the socket housing containing the at least two recessed nested contact surfaces and the insulating material.

According to further embodiments of the present invention, the power grid voltage supply to an electric device is suitable for any voltage area. Examples of voltages are 110 volts in the US and 220-240 volts for most of Europe and Australia. Banana type plugs are common in the sound, music and telephone industries and are used for low current. According to the present invention, the electric connection is configured to support an electric current with an upper limit in the range of 0.15 amperes to 16 amperes. According to further embodiments of the present invention, the electric current has an upper limit in the range of 2.5 amperes to 10 amperes. According to further embodiments of the present invention, the electric current has an upper limit in the range of 0.15 amperes to 5 amperes.

The at least two nested insulated electric contact surfaces are concentrically arranged as illustrated in FIG. 2b. Alternately, the at least two nested insulated electric contact surfaces are non-concentrically arranged. The perpendicular cross-section of the at least two recessed and the at least two protruding nested insulated electric contact surfaces can be in any shape such as a circle, a rectangle, a square, a triangle, an ellipse, and another polygon.

FIG. 2c is an illustration of the electric wiring of a typical multiple gang outlet, shown here as a four gang outlet as an unlimiting example. The parts are seen from the inside of the wall to the outside. Three wires 52 lead into the outlet from inside the wall from the power grid. The wires do not have to be different from wiring used prior to this invention, such that the changes for this invention need only to be made for the plugs 42 and outlet. The wiring 54 within multiple gang outlet 40 connects between sockets 42, an electric wire connecting hot recessed connecting surfaces 50, an electric wire connecting neutral recessed connecting surfaces 48 and an electric wire connecting ground recessed connecting surfaces 46. In some cases separate electric lines can feed electricity into the individual sockets of the multiple-gang outlet In some cases there is a retractable cover over the sockets to protect children from sticking objects into the socket.

In a further embodiment of the present invention, adapters are used to connect between “standard” plugs and sockets and the plugs and sockets disclosed in the present invention. An adapter for the connection of a standard plug to a banana type socket would be made of a standard socket on one end and a banana type plug on the other end of the adapter. An adapter for the connection of a banana type plug to a standard type socket would be made of a banana type socket on one end of the adapter and a standard plug at the other end of the adapter. This invention addresses the need for a universal plug and socket by describing a banana type plug and socket which could be adopted by many countries which today are plagued by different plugs and sockets in different areas, necessitating all kinds of intricate adapters.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method of reducing the space required for an AC electric connection, the method comprising the steps of:
arranging at least two nested insulated electric contact surfaces, said arranging arranged such that said at least two nested insulated electric contact surfaces are longer in the axial direction than in the transverse direction, and
providing an AC current suitable for powering an electric device;
wherein said contact surfaces are constructed to safely conduct an electric current supplied by a power grid.

2. The method of claim 1 wherein said at least two nested insulated electric contact surfaces are selected from the group consisting of:
(a) plus;
(b) minus; and
(c) ground.

3. The method of claim 1, wherein said power grid supplies a potential difference range of 100 volts to 250 volts AC.

4. The method of claim 3, wherein said potential difference is approximately 110 volts AC.

5. The method of claim 3, wherein said potential difference is approximately 220 volts AC.

6. The method of claim 1, wherein said electric current has an upper limit in the range of 0.15 amperes to 16 amperes.

7. The method of claim 6, wherein said electric current has an upper limit in the range of 0.15 amperes to 5 amperes.

8. The method of claim 7, wherein said electric current has an upper limit in the range of 2.5 amperes to 10 amperes.

9. The method of claim 1, wherein said at least two nested insulated electric contact surfaces are each independently characterized by a perpendicular cross section selected from the group consisting of a circle, a rectangle, a square, a triangle, an ellipse, and another polygon.

10. The method of claim 1, wherein said at least two nested insulated electric contact surfaces are concentrically arranged.

11. The method of claim 1, wherein said at least two nested insulated electric contact surfaces are non-concentrically arranged.

12. The method of claim 1, wherein said at least nested insulated electric contact surfaces comprise three leads:
(a) an innermost plus lead;
(b) an intermediate minus lead; and
(c) an outermost ground lead.

13. The method of claim 1, wherein the surface area required to establish the AC electric connection is not greater than approximately 3 square centimeters.

14. An electrical connection for AC current supplied by a power grid, the connection comprising:
(a) a socket, said socket comprising:
(i) at least two recessed nested contact surfaces, each of said recessed nested contact surfaces constructed of a conductive material; and
(ii) insulating material, said insulating material effectively preventing a flow of electric current between said recessed nested contact surfaces;
(iii) a socket housing; said socket housing containing said at least two recessed nested contact surfaces and said insulating material; and
(b) a plug, said plug comprising;
(i) at least two protruding nested contact surfaces, each of said protruding nested contact surfaces constructed of a conductive material; and
(ii) insulating material, said insulating material effectively preventing a flow of electric current between said protruding nested contact surfaces;
(iii) a plug housing; said plug housing containing said at least two protruding nested contact surfaces and said insulating material; and
wherein said plug is insertable in said socket such that the electrical connection is formed; and
wherein said connection is capable of safely conducting an electric current supplied by a power grid.

15. The electrical connection of claim 14, wherein said at least two recessed and protruding nested insulated electric contact surfaces fulfill functions selected from the group consisting of:
(a) plus lead;
(b) minus lead; and
(c) ground lead.

16. The electrical connection of claim 14, wherein said power grid supplies a potential difference range of 100 volts to 250 volts AC.

17. The electrical connection of claim 16, wherein said potential difference is approximately 110 volts AC.

18. The electrical connection of claim 16, wherein said potential difference is approximately 220 volts AC.

19. The electrical connection of claim 14, wherein said electric current has an upper limit in the range of 0.15 amperes to 16 amperes.

20. The electrical connection of claim 19, wherein said electric current has an upper limit in the range of 0.15 amperes to 5 amperes.

21. The electrical connection of claim 20, wherein said electric current has an upper limit in the range of 2.5 amperes to 10 amperes.

22. The electrical connection of claim 14, wherein said at least two recessed nested insulated electric contact surfaces are each independently characterized by a perpendicular cross section selected from the group consisting of a circle, a rectangle, a square, a triangle, an ellipse, and another polygon.

23. The electrical connection of claim 14, wherein said at least two protruding nested insulated electric contact surfaces are each independently characterized by a perpendicular cross section selected from the group consisting of a circle, a rectangle, a square, a triangle, an ellipse, and another polygon.

24. The electrical connection of claim 14, wherein said at least two nested insulated electric contact surfaces are concentrically arranged.

25. The electrical connection of claim 14, wherein said at least two nested insulated electric contact surfaces are non-concentrically arranged.

26. The electrical connection of claim 14, wherein said at least two nested insulated electric contact surfaces comprise three nested insulated electric contact surfaces:
(a) an innermost plus lead;
(b) an intermediate minus lead; and
(d) an outermost ground lead.

27. The electrical connection of claim 14, wherein a perpendicular cross-sectional surface area of said socket housing and said plug housing are each less than approximately 3 square centimeters.

28. An electrical socket capable of establishing a connection for AC current supplied by a power grid, said socket comprising:
(a) at least two recessed nested contact surfaces, each of said recessed nested contact surfaces constructed of a conductive material;
(b) insulating material, said insulating material effectively preventing a flow of electric current between said recessed nested contact surfaces; and
(c) a socket housing; said socket housing containing said at least two recessed nested contact surfaces and said insulating material;
wherein said socket is capable of safely conducting an electric current supplied by a power grid.

29. The electrical socket of claim 28, wherein said at least two recessed nested insulated electric contact surfaces fulfill functions selected from the group consisting of:
(a) plus lead;
(b) minus lead; and
(c) ground lead.

30. The electrical socket of claim 28, wherein said power grid supplies a potential difference range of 100 volts to 250 volts AC.

31. The electrical socket of claim 30, wherein said potential difference is approximately 110 volts AC.

32. The electrical socket of claim 30, wherein said potential difference is approximately 220 volts AC.

33. The electrical socket of claim 28, wherein said electric current has an upper limit in the range of 0.15 amperes to 16 amperes.

34. The electrical socket of claim 33, wherein said electric current has an upper limit in the range of 0.15 amperes to 5 amperes.

35. The electrical socket of claim 34, wherein said electric current has an upper limit in the range of 2.5 amperes to 10 amperes.

36. The electrical socket of claim 28, wherein said at least two recessed nested insulated electric contact surfaces are each independently characterized by a perpendicular cross section selected from the group consisting of a circle, a rectangle, a square, a triangle, an ellipse, and another polygon.

37. The electrical socket of claim 28, wherein said at least two nested insulated electric contact surfaces are concentrically arranged.

38. The electrical socket of claim 28, wherein said at least two nested insulated electric contact surfaces are non-concentrically arranged.

39. The electrical socket of claim 28, wherein said at least two nested insulated electric contact surfaces comprise three nested insulated electric contact surfaces:
(a) an innermost plus lead;
(b) an intermediate minus lead; and
(e) an outermost ground lead.

40. The electrical socket of claim 28, wherein a perpendicular cross sectional surface area of said socket housing is less than approximately 3 square centimeters.

41. An electrical plug capable of establishing a connection for AC current supplied by a power grid, said plug comprising:
(a) at least two protruding nested contact surfaces, each of said protruding nested contact surfaces constructed of a conductive material;
(b) insulating material, said insulating material effectively preventing a flow of electric current between said protruding nested contact surfaces; and
(c) a plug housing; said plug housing containing said at least two protruding nested contact surfaces and said insulating material;
wherein said plug is capable of safely conducting an electric current supplied by a power grid.

42. The electrical plug of claim 41, wherein said at least two protruding nested insulated electric contact surfaces fulfill functions selected from the group consisting of:
(a) plus lead;
(b) minus lead; and
(c) ground lead.

43. The electrical plug of claim 41, wherein said power grid supplies a potential difference range of 100 volts to 250 volts AC.

44. The electrical plug of claim 43, wherein said potential difference is approximately 110 volts AC.

45. The electrical plug of claim 43, wherein said potential difference is approximately 220 volts AC.

46. The electrical plug of claim 41, wherein said electric current has an upper limit in the range of 0.15 amperes to 16 amperes.

47. The electrical plug of claim 46, wherein said electric current has an upper limit in the range of 0.15 amperes to 5 amperes.

48. The electrical plug of claim 47, wherein said electric current has an upper limit in the range of 2.5 amperes to 10 amperes.

49. The electrical plug of claim 41, wherein said at least two protruding nested insulated electric contact surfaces are each independently characterized by a perpendicular cross section selected from the group consisting of a circle, a rectangle, a square, a triangle, an ellipse, and another polygon.

50. The electrical plug of claim 41, wherein said at least two nested insulated electric contact surfaces are concentrically arranged.

51. The electrical plug of claim 41, wherein said at least two nested insulated electric contact surfaces are non-concentrically arranged.

52. The electrical plug of claim 41, wherein said at least two nested insulated electric contact surfaces comprise three nested insulated electric contact surfaces:
(a) an innermost plus lead;
(b) an intermediate minus lead; and
(c) an outermost ground lead.

53. The electrical plug of claim 41, wherein a perpendicular cross-sectional surface area of said plug housing is less than approximately 3 square centimeters.
